(19) United States
(12) Patent Application Publication
(10) Pub. No.: US 2019/0204650 A1
(43) Pub. Date: Jul. 4, 2019

(54) SUBSTRATE AND DEVICE FOR MANUFACTURING THE SAME, MANUFACTURING METHOD, AND DISPLAY DEVICE

(71) Applicants: BOE TECHNOLOGY GROUP CO., LTD., Beijing (CN); Chongqing BOE Optoelectronics Technology Co., Ltd., Chongqing (CN)

(72) Inventors: Bin Wan, Beijing (CN); Min Li, Beijing (CN); Chao Liu, Beijing (CN); Ruilin Bi, Beijing (CN)

(21) Appl. No.: 16/057,465

(22) Filed: Aug. 7, 2018

(30) Foreign Application Priority Data
Jan. 2, 2018 (CN) 201810002986.4

(51) Int. Cl. G02F 1/1343; G02F 1/1335; C03B 17/06; C03B 17/02; B32B 17/06; C03C 3/091

(52) U.S. Cl. CPC G02F 1/13439; G02F 1/133516; C03B 17/064; C03B 17/02; G02F 1/13394; C03C 3/091; G02F 2201/121; G02F 2202/09; G02F 2202/16; B32B 17/06

(57) ABSTRACT

The present disclosure relates to a substrate, a device for manufacturing the substrate, a manufacturing method and a display device, which belong to display related technical field. The substrate has a single layer structure and includes a conductive portion and a non-conductive portion in a thickness direction.

### CROSS-REFERENCE TO RELATED APPLICATIONS

This application claims priority to Chinese Patent Application 201810002986.4, filed Jan. 2, 2018, the entire contents of which are incorporated herein by reference.

### TECHNICAL FIELD

The present disclosure relates to glass manufacturing technologies and display technologies, and particularly to a substrate, a device for manufacturing the substrate, a manufacturing method and a display device.

### BACKGROUND

In the manufacturing process of conventional substrates, if it is necessary to form a conductive layer on the substrate, it is necessary to form indium tin oxides (ITO), black matrix (BM), RGB, OC, and photo spacer (PS) on the substrate. For example, in the fabrication of the existing TN type color filter substrate, an ITO electrode layer is coated on the surface of a color filter layer, and the indium tin oxide electrode layer is used as a common electrode of a liquid crystal display color filter substrate. The common electrode and pixel electrodes of an array substrate form an electric field, and the deflection of the liquid crystal molecules is controlled by the change of the electric field, thus realizing display effect. In the fabrication of an Advanced Super Dimension Switch (ADS) type color filter substrate, an indium tin oxide electrode layer is coated on the back surface of a substrate to shield the external electric field of the liquid crystal display, and the presence of the external electric field is prevented from affecting the display of the ADS type liquid crystal display. The indium tin oxide electrode layer is formed by a magnetron sputtering process. During the magnetron sputtering process, it is easy to form ITO particles. The presence of the ITO particles may reduce the yield of liquid crystal display panels. Moreover, the addition of the ITO process also increases the production line input and the production cost of displays, and reduces the competitiveness of products. Therefore, it is very important to find a way to avoid the ITO process.

### SUMMARY

Arrangements of the present disclosure provide a substrate, a device for manufacturing the substrate, a manufacturing method and a display device, so as to avoid the IOT layer structure in existing substrates, and thus to simplify the process, increase the product yield, reduce production cost and enhance product competitiveness.

According to some arrangements of the present disclosure, there is provided a substrate. The substrate has a single layer structure and includes a conductive portion and a non-conductive portion in a thickness direction.

According to an exemplary arrangement, a ratio of a thickness of the conductive portion to a thickness of the non-conductive portion ranges from 1:1 to 1:4.

According to an exemplary arrangement, the substrate has a thickness ranging from 0.4 mm to 1.0 mm.

According to an exemplary arrangement, the non-conductive portion includes SiO₂, Al₂O₃, B₂O₃, BaO, CaO, MgO, SnO₂, SrO, and Fe₂O₃.

The conductive portion includes SiO₂, Al₂O₃, B₂O₃, BaO, CaO, MgO, SnO₂, SrO, Fe₂O₃, and one or more of zinc oxide, nano silver, indium oxide, and tin oxide.

According to an exemplary arrangement, mass percentages of materials in the non-conductive portion are: 60%˜73% for SiO₂, 5%˜22% for Al₂O₃, 1%˜6% for B₂O₃, 5%˜15% for BaO, 0%˜20% for SrO, 0%˜13% for CaO, 0%˜11% for MgO, 0.005%˜2% for SnO₂, and 0.003%˜0.1% for Fe₂O₃.

Mass percentages of materials in the conductive portion are: 50%˜65% for SiO₂, 4%˜18% for Al₂O₃, 1%˜5% for B₂O₃, 4%˜13% for BaO, 0%˜15% for SrO, 0%˜10% for CaO, 0%˜9% for MgO, 0.005%˜1.5% for SnO₂, 0.003%˜0.1% for Fe₂O₃, 0%˜20% for zinc oxide, 0%˜20% for nano silver, 0%˜20% for indium oxide, and 0%˜20% for tin oxide; wherein a total mass percentage of the zinc oxide, the nano silver, the indium oxide, and the tin oxide is 15%˜30%.

According to some arrangements of the present disclosure, there is provided a device for manufacturing the substrate.

The device includes a body including a first side wall, a second side wall, and a partition plate, wherein the first side wall and the partition plate form a first overflow tank, and the second side wall and the partition plate form a second overflow tank.

A bottom of the body is provided with a flow guiding structure which is configured to form the substrate by guiding melt overflowing along the first side wall and the second side wall.

According to an exemplary arrangement, the first side wall and the second side wall extend downward along an outer side of the body and converge at the bottom of the body to form the flow guiding structure; or the bottom of the body is provided with an opening, and the partition plate protrudes from the opening to form the flow guiding structure.

According to some arrangements of the present disclosure, there is provided a method for manufacturing a substrate using the device as mentioned above.

The method includes introducing conductive melt into the first overflow tank, and introducing non-conductive melt the second overflow tank., enabling the conductive melt and the non-conductive melt to overflow from the first overflow tank and the second overflow tank, respectively, and to flow through the flow guiding structure along the first side wall and the second side wall to form a substrate strip, and after the substrate falls down, forming the substrate including a conductive portion and a non-conductive portion by drawing.

According to an exemplary arrangement, the enabling the conductive melt and the non-conductive melt to overflow from the first overflow tank and the second overflow tank, respectively, and to flow through the flow guiding structure along the first side wall and the second side wall to form a substrate strip, includes according to a thickness of the substrate and a design requirement of a thickness ratio of the conductive portion and the non-conductive portion, controlling overflow speeds of the conductive melt and the non-conductive melt to enable formation of the substrate strip by guiding the conductive melt and the non-conductive melt using the flow guiding structure.

According to an exemplary arrangement, the non-conductive melt includes SiO₂, Al₂O₃, B₂O₃, BaO, CaO, MgO, SnO₂, SrO, and Fe₂O₃.

The conductive melt includes SiO₂, Al₂O₃, B₂O₃, BaO, CaO, MgO, SnO₂, SrO, Fe₂O₃, and one or more of zinc oxide, nano silver, indium oxide, and tin oxide.

According to an exemplary arrangement, mass percentages of materials in the non-conductive melt are: 60%˜73% for SiO₂, 5%˜22% for Al₂O₃, 1%˜6% for B₂O₃, 5%˜15% for BaO, 0%˜20% for SrO, 0%˜13% for CaO, 0%˜11% for MgO, 0.005%˜2% for SnO₂, and 0.003%˜0.1% for Fe₂O₃.

Mass percentages of materials in the conductive melt are:50%˜65% for SiO₂, 4%˜18% for Al₂O₃, 1%˜5% for B₂O₃, 4%˜13% for BaO, 0%˜15% for SrO, 0%˜10% for CaO, 0%˜9% for MgO, 0.005%˜1.5% for SnO₂, 0.003%˜0.1% for Fe₂O₃, 0%˜20% for zinc oxide, 0%˜20% for nano silver, 0%˜20% for indium oxide, and 0%˜20% for tin oxide; wherein a total mass percentage of the zinc oxide, the nano silver, the indium oxide, and the tin oxide is 15%˜30%.

According to some arrangements of the present disclosure, there is provided a display device, including the substrate as mentioned above.

According to an exemplary arrangement, the display device includes an array substrate, and the substrate is disposed opposite to the array substrate.

The conductive portion in the substrate is disposed at a side close to the array substrate as a common electrode layer, and the non-conductive portion in the substrate is disposed at a side away from the array substrate; or the conductive portion in the substrate is disposed at a side away from the array substrate, and the non-conductive portion in the substrate is disposed at a side close to the array substrate.

### BRIEF DESCRIPTION OF THE DRAWINGS

FIG. 1 is a schematic structural view of a substrate for use in an ADS type color filter substrate according to an arrangement of the present disclosure.

FIG. 2 is a schematic structural view of a substrate for use in a TN type color filter substrate according to an arrangement of the present disclosure.

FIG. 3 is a schematic structural view of a device for manufacturing a substrate according to an arrangement of the present disclosure.

FIG. 4 is a schematic structural view of a device for manufacturing a substrate according to an arrangement of the present disclosure.

FIG. 5 is a flowchart of a method for manufacturing a substrate according to an arrangement of the present disclosure.

### DETAILED DESCRIPTION

In order to make the objectives, technical solutions and advantages of the present disclosure more clear, the present disclosure will be further described in detail below with reference to the specific arrangements and the accompanying drawings.

It should be noted that all the expressions such as “first” and “second” in the arrangements of the present disclosure are used to distinguish two entities that have the same name but are not the same or non-identical parameters. The terms “first” and “second” are used for the convenience of the description, but should not be construed as limiting the arrangements of the present disclosure. This will not be described again in the following arrangements.

In view of the defects in the existing ITO-based substrates, the inventors have found that the prior art has at least the following problems. In the existing color filter substrates, when the ITO layer is manufactured, particles are easy to form, thus reducing the yield of display panels, and accordingly increasing the production costs. Therefore, the present disclosure is directed to the functional role of the ITO layer, and proposes a solution that avoids the need in the prior art for the preparation of the ITO layer by magnetron sputtering in a subsequent process.

Arrangement 1

In view of the problem with the ITO layer in conventional substrates, one of the objectives of the present disclosure is to eliminate the manufacturing process of the ITO layer in a color filter substrates, thus reducing the production costs of display devices and improving the yield. Based on the above analysis, whether the required functional layer of the ITO layer is prefabricated into the substrate is taken into account by the arrangement, thus avoiding subsequent processing. Thus, an improved substrate structure is proposed. Specifically, the substrate described in the present disclosure has a single layer structure and includes a conductive portion and a non-conductive portion along the thickness direction of the substrate. The single layer structure is integrally formed and inseparable. In this way, the stability of the entire substrate structure can be ensured, and process is not required to be added in the subsequent processes, which simplifies the processes. Further, in order to prepare the above-mentioned substrate having both the conductive portion and the non-conductive portion, overflow drawing or other available process can be used, and the specific preparation processes are described later. In this way, in the substrate having a single-layered structure, it is possible to simultaneously have two different structural portions in the thickness direction, and the conductive portion and the non-conductive portion have no obvious boundary with each other and are isolated from each other, and finally the conductive portion and the non-conductive portion are used to perform different functions in the substrate. In this way, the conductive portion in the substrate can be used to replace the ITO layer in the existing structure to perform the same function, and the non-conductive portion can be used to support and protect the substrate.

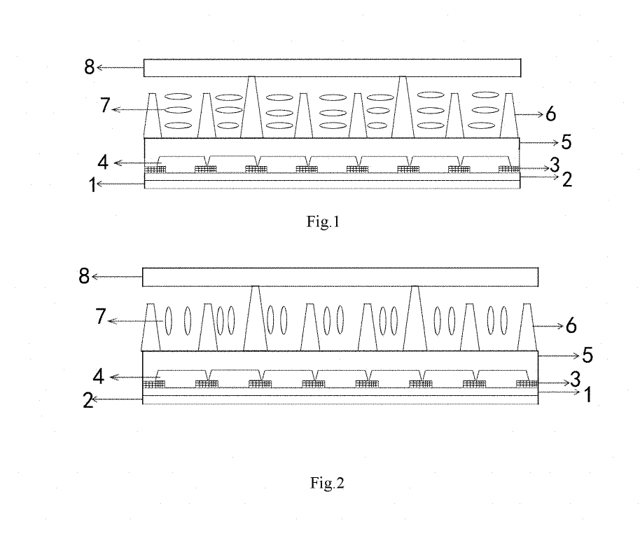

FIGS. 1 and 2 are schematic structural views of substrates for use in an ADS type color filter substrate and a TN type color filter substrate according to arrangements of the present disclosure. As shown in FIG. 1, when the substrate is used in the ADS type color filter substrate, based on the ADS type display mode, an ITO layer is formed on the back surface of the substrate to shield the external electric field. In the substrate according to the arrangement, the substrate has a conductive portion 1, and the conductive portion 1 in the substrate can be directly disposed at a side away from an array substrate 8, and a non-conductive portion 2 in the substrate is disposed at a side close to the array substrate 8. Thus, it is also possible to make the conductive portion 1 at the bottom of the substrate function to shield the external electric field. That is, in this structure, it is not necessary to additionally add an ITO layer.

It can be seen from FIG. 2 that when the substrate is used in a TN type color filter substrate, it is required to apply an indium tin oxide electrode layer (ITO) on the surface of the color filter layer, and the indium tin oxide electrode layer is used as a common electrode of the color filter substrate of the liquid crystal display, and the common electrode and the pixel electrodes in the array substrate 8 form an electric field. The deflection of the liquid crystal molecules is controlled by the change of the electric field, thus realizing the display effect. Similarly, the substrate according to the arrangement has the conductive portion 1, and the conductive portion 1 can serve as the common electrode to form a corresponding control electric field. Accordingly, the conductive portion in the substrate of the arrangement can be disposed at a side close to the array substrate 8 as a common electrode layer, and the non-conductive portion 2 in the substrate is disposed at a side away from the array substrate 8. Thus, the conductive portion 1 in the substrate can be directly used as the common electrode, and the process for manufacturing the ITO layer in subsequent processes is not needed.

As can be seen from the above arrangements, in the substrate of the arrangement, the substrate is designed as a single-layered structure including a conductive portion and a non-conductive portion in a thickness direction. The conductive portion can be used as an ITO layer in an ADS type color filter substrate to shield external electric field, or can be used as a common electrode layer in a TN type color filter substrate. That is, with the substrate structure as provided by arrangement of the present disclosure, manufacturing of ITO layer structure is not needed, regardless of the display modes. Thus, The ITO layer structure in existing substrates can be avoided, thus simplifying processes, increasing yield of products, reducing costs and enhancing competitiveness.

Arrangement 2

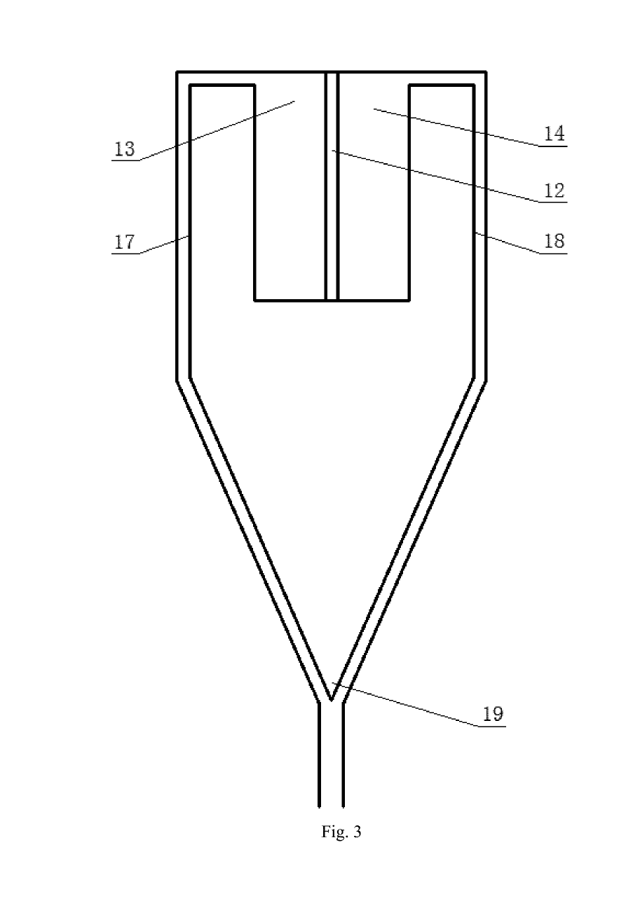

The substrate provided by arrangements of the present disclosure has a structure having two portions of different properties. Accordingly, the present arrangement provides a device for manufacturing a substrate. Referring to FIG. 3, the manufacturing device includes a body. The body includes a first side wall 17, a second side wall 18, and a partition plate 12. The first side wall 17 and the partition plate 12 form a first overflow tank 13. The second side wall 18 and the partition plate 12 form a second overflow tank 14. The bottom of the body is provided with a flow guiding structure 19. The flow guiding structure 19 is configured to form the substrate by guiding melt (i.e., a molten material in liquid form) overflowing along the first side wall 17 and the second side wall 18. That is, the conductive melt for preparing the conductive portion of the substrate and the non-conductive melt for preparing the non-conductive portion of the substrate are placed in the first overflow tank 13 and the second overflow tank 14, respectively. The melt overflowing from the overflow tank 13 and the second overflow tank 14 can overflow downward along the first side wall 17 and the second side wall 18, respectively. In this way, a substrate having both a conductive portion and a non-conductive portion can be accurately and efficiently prepared, and the functional layer having the same function as that of the ITO layer can be fused to the substrate, which can simplify subsequent processes, improve product yield and reduce production costs.

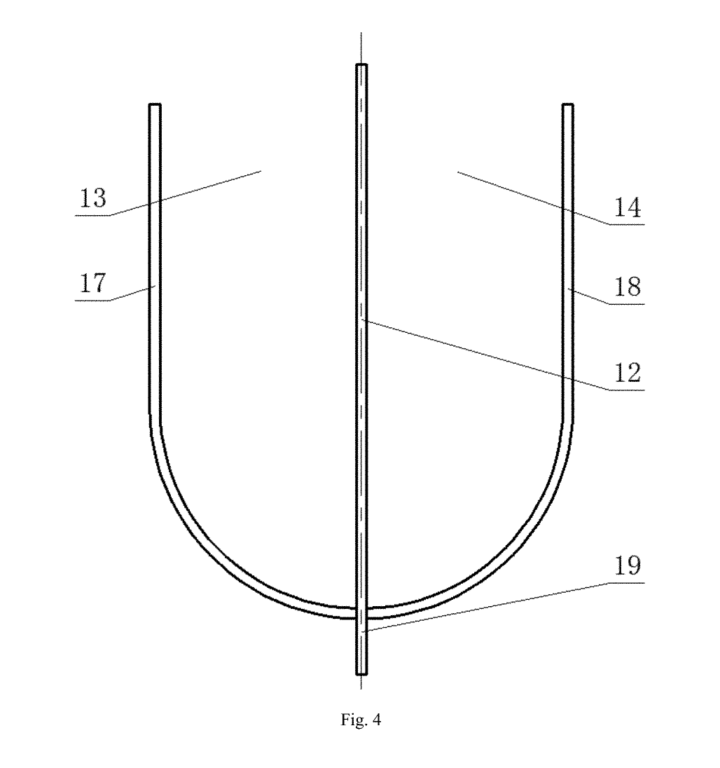

In some exemplary arrangements, as shown in FIG. 3, the first side wall 17 and the second side wall 18 extend downward along the outer side of the body and converge at the bottom of the body to form the flow guiding structure 19. Alternatively, as shown in FIG. 4, the bottom of the body is provided with an opening, and the partition plate 12 protrudes from the opening to form the flow guiding structure 19.

Preferably, the partition plate 12 uniformly divides the interior of the body into two symmetrical tanks: the first overflow tanks 13 and second overflow tanks 14.

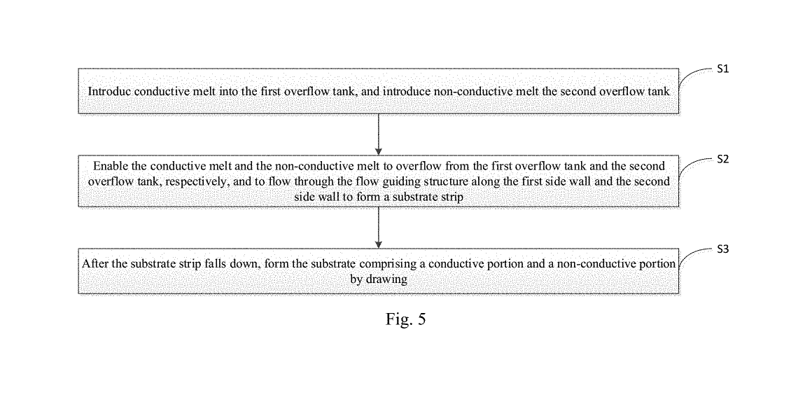

Further, a method for preparing the substrate using the above manufacturing device is provided. Referring to FIG. 5, the method for preparing the substrate includes the following.

In S1, conductive melt is introduced into the first overflow tank 13, and non-conductive melt is introduced into the second overflow tank 14. In some cases, the substrate is a transparent structure. Under such condition, the substrate is manufactured by using glass materials. That is, the conductive molten metal is a conductive glass melt (i.e., molten glass in liquid form), and the non-conductive melt is non-conductive glass melt. Of course, the present disclosure is not limited to the use of the glass material.

In S2, the conductive melt and the non-conductive melt overflow from the first overflow tank and the second overflow tank, respectively, and flow through the flow guiding structure along the first side wall and the second side wall to form a substrate strip. Preferably, when the conductive melt and the non-conductive melt overflow from the first overflow tank and the second overflow tank, respectively, according to a thickness of the substrate and a design requirement of a thickness ratio of the conductive portion and the non-conductive portion, overflow speeds of the conductive melt and the non-conductive melt are controlled to enable formation of the substrate strip by guiding the conductive melt and the non-conductive melt using the flow guiding structure. That is, when the molten liquid level exceeds the heights of the left and right sides of the overflow tanks, the conductive melt and the non-conductive melt flow down the overflow side walls to form at the bottom of the overflow tanks a substrate strip containing both the conductive portion 1 and the non-conductive portion 2 by the flow guiding structure.

In S3, after the substrate strip falls down, the substrate including the conductive portion and the non-conductive portion is formed by drawing. Preferably, the substrate is formed by drawing of a mechanical down-draw roll.

As can be seen from the above arrangements, the above-mentioned preparation processes enable stable and reliable preparation of the substrate containing both the conductive portion 1 and the non-conductive portion 2. The processes are controllable based on the overflow preparation processes. The resulted conductive portion 1 and non-conductive portion 2 are colorless and transparent, and there is no significant boundary between the conductive portion 1 and the non-conductive portion 2, so that no additional interference is caused. In addition, the above-mentioned melt-separated overflow technique can produce an ultra-thin glass substrate with double original glass surfaces. As compared with conventional technologies in which only single original glass surface is formed by suing a float technology or no original glass surface can be formed by using a slot down draw technology, the present disclosure can eliminate post-processing processes such as grinding or polishing. Also, during the preparation of flat display devices, there is no need to pay attention to the difference in the properties of the glass surfaces due to the different glass surfaces that are both original and in contact with liquid tin, or in contact with the grinding media.

Arrangement 3

The present disclosure also provides a material composition for preparing the substrate and a corresponding size ratio design with respect to the structure of the substrate, so that further optimization of the substrate can be achieved. Specifically, for the size ratio design, the arrangement discloses a thickness range of the substrate. The thickness range may be 0.4 mm to 1.0 mm, for example, 0.4 mm, 0.5 mm, 0.7 mm, 0.9 mm, and 1.0 mm. Such a thickness range can be easily realized or prepared during processes, and can function to make a response in the display device while ensuring quality or service life. Further, a range of a thickness ratio of the conductive portion to the non-conductive portion is also disclosed, which is 1:11:4. For example, the ratio is 1:1, 1:2, 1:3, or 1:4. In this way, the substrate can be made to have sufficient supporting function while realizing the function of the ITO layer.

For the material component design, considering that glass materials are generally used to make the substrate to realize transparent display effect, the arrangement discloses the following compositions. The non-conductive portion includes SiO₂, Al₂O₃, B₂O₃, BaO, CaO, MgO, SnO₂, SrO and Fe₂O₃ as the main glass materials. The conductive portion includes SiO₂, Al₂O₃, B₂O₃, BaO, CaO, MgO, SnO₂, SrO, Fe₂O₃, and one or more of zinc oxide, nano silver, indium oxide and tin oxide. Among them, zinc oxide, nano silver, indium oxide and tin oxide are conductive materials having a conductive function. It should be noted that the above is only an example of an optional material composition, and other necessary materials or other conductive materials having conductive functions may also be included, and the present disclosure does not impose specific limitations on this.

Further, the mass percentages of the materials in the non-conductive portion are as follows. The mass percentage of SiO₂ is 60% to 73%, the mass percentage of Al₂O₃ is 5% to 22%, the mass percentage of B₂O₃ is 1% to 6%, the mass percentage of BaO is 5% to 15%, the mass percentage of SrO is 0%˜20%, the mass percentage of CaO is 0%˜13%, the mass percentage of MgO is 0%˜11%, the mass percentage of SnO₂ is 0.005%˜2%, and the mass percentage of Fe₂O₃ is 0.003%˜0.1%.

The mass percentages of the materials in the conductive portion are as follows. The mass percentage of SiO₂ is 50% to 65%, the mass percentage of Al₂O₃ is 4% to 18%, the mass percentage of B₂O₃ is 1% to 5%, the mass percentage of BaO is 4% to 13%, the mass percentage of SrO is 0% to 15%, the mass percentage of CaO is 0% to 10%, the mass percentage of MgO is 0% to 9%, the mass percentage of SnO₂ is 0.005% to 1.5%, the mass percentage of Fe₂O₃ is 0.003% to 0.1%, the mass percentage of zinc oxide is 0% to 20%, the mass percentage of nano silver is 0% to 20%, the mass percentage of indium oxide is 0% to 20%, and the mass percentage of tin oxide is 0% to 20%. The total mass percentage of the zinc oxide, the nano silver, the indium oxide, and the tin oxide is 15% to 30%. It should be noted that the mass percentages of the above materials only list the exemplary range of ratios, and the actual materials can be designed and adjusted according to requirements. For example, SiO₂ can be selected from any value in the range of 60% to 73%, for example, 60%, 62%. 64%, 65%, 67%, 69%, 71%, 73%, etc. This also applies to the rest of the materials.

Arrangement 4

The present disclosure also provides a display device including the substrate as described above. The purpose of the present disclosure is to eliminate the manufacturing process of the ITO layer in the color filter substrate, thus reducing the production cost of the display.

According to an exemplary arrangement, the display device of the present disclosure includes a substrate having a conductive portion and a non-conductive portion, a black matrix 3 directly disposed on the substrate, a color resist layer 4 directly disposed on the black matrix 3, a flat protective layer 5, and a support spacer 6 disposed on the flat protective layer 5. The BM (black matrix), RGB (color resist layer), OC (flat protective layer), and PS layer (support spacer) are formed on the substrate by sequential processes such as coating, exposure, development, baking, and the like to obtain a color filter substrate. The liquid crystal 7 is sandwiched between the color filter substrate and the array substrate, and then the color filter substrate and the array substrate 8 are paired to form a complete display device.

The substrate is prepared by using a separation overflow method, and no additional processes are added during the manufacturing processes. The substrate of the present disclosure includes the conductive portion and the non-conductive portion at the same time as compared with the conventional substrates. The conductive portion and the non-conductive portion each contain main glass components such as SiO₂, Al₂O₃, B₂O₃, BaO, CaO, MgO, SnO₂, SrO, and Fe₂O₃. The glass components of the conductive portion further include one or more of conductive materials having conductive functions such as zinc oxide, nano silver, indium oxide, and tin oxide.

For example, the above-mentioned substrate can be suitable for both ADS type and TN type liquid crystal display modes according to the orientation of the conductive portion. When the conductive portion faces downward, the conductive portion can function to shield the external electric field, thus not affecting the liquid crystal deflection of the ADS type liquid crystal display. When the conductive portion faces upward, the conductive portion itself can serve as a conductive common electrode, and the conductive common electrode can form an electric field with the pixel electrodes in the array display substrate of the TN type liquid crystal display panel, thus controlling the deflection of the liquid crystal molecules to achieve a display effect.

That is, the display device of the present disclosure does not require the fabrication of an ITO layer, regardless of whether it is applied to an ADS type or a TN type liquid crystal display. As compared with the manufacturing process of conventional display devices, the present disclosure eliminates the production of the ITO layer, not only reduces the input of apparatus, but also greatly increases the production capacity of the production line, reduces the production cost of the display, and improves product yield because the affect caused by the ITO layer is reduced. In addition, when the base substrate is applied to a TN type liquid crystal display, the conductive portion 1 on the substrate can directly guide the static electricity generated by the black matrix and the color resist layer material out of the liquid crystal display device to avoid display failure caused by the presence of static electricity in the black matrix and color resist layer, thus improving product quality.

It should be understood by those of ordinary skill in the art that the discussion of any of the above arrangements is merely exemplary, and is not intended to suggest that the scope of the disclosure (including the claims) is limited to these examples. Under the spirit of the present disclosure, different arrangements or the technical features in the different arrangements can also be combined, the steps can be carried out in any order, and there are many other variations according to various aspects of the present disclosure as described above, which are not provided in the details for the sake of brevity.

All such alternatives, modifications, and variations are intended to be included within the scope of the appended claims. Therefore, any omissions, modifications, equivalent substitutions, improvements, etc. that are made within the spirit and scope of the present disclosure are intended to be included within the scope as defined by the appended claims.

What is claimed is:

1. A substrate, wherein the substrate has a single layer structure and comprises a conductive portion and a non-conductive portion in a thickness direction.

2. The substrate according to claim 1, wherein a ratio of a thickness of the conductive portion to a thickness of the non-conductive portion ranges from 1:1 to 1:4.

3. The substrate according to claim 1, wherein the substrate has a thickness ranging from 0.4 mm to 1.0 mm.

4. The substrate according to claim 1, wherein:
the non-conductive portion comprises SiO₂, Al₂O₃, B₂O₃, BaO, CaO, MgO, SnO₂, SrO, and Fe₂O₃; and
the conductive portion comprises SiO₂, Al₂O₃, B₂O₃, BaO, CaO, MgO, SnO₂, SrO, Fe₂O₃, and one or more of zinc oxide, nano silver, indium oxide, and tin oxide.

5. The substrate according to claim 4, wherein mass percentages of materials in the non-conductive portion are: 60% 73% for SiO₂, 5%˜22% for Al₂O₃, 1%˜6% for B₂O₃, 5%˜15% for BaO, 0%˜20% for SrO, 0%˜13% for CaO, 0%˜11% for MgO, 0.005%˜2% for SnO₂, and 0.003%˜0.1% for Fe₂O₃; and
mass percentages of materials in the conductive portion are: 50%˜65% for SiO₂, 4%˜18% for Al₂O₃, 1%˜5% for B₂O₃, 4%˜13% for BaO, 0%˜15% for SrO, 0%˜10% for CaO, 0%˜9% for MgO, 0.005%˜1.5% for SnO₂, 0.003%˜0.1% for Fe₂O₃, 0%˜20% for zinc oxide, 0%˜20% for nano silver, 0%˜20% for indium oxide, and 0%˜20% for tin oxide; wherein a total mass percentage of the zinc oxide, the nano silver, the indium oxide, and the tin oxide is 15%˜30%.

6. A device for manufacturing a substrate, wherein the substrate has a single layer structure and comprises a conductive portion and a non-conductive portion in a thickness direction,
wherein the device comprises:
a body comprising a first side wall, a second side wall, and a partition plate, wherein the first side wall and the partition plate form a first overflow tank, and the second side wall and the partition plate form a second overflow tank;
wherein a bottom of the body is provided with a flow guiding structure which is configured to form the substrate by guiding melt overflowing along the first side wall and the second side wall.

7. The device according to claim 6, wherein:
the first side wall and the second side wall extend downward along an outer side of the body and converge at the bottom of the body to form the flow guiding structure; or,
the bottom of the body is provided with an opening, and the partition plate protrudes from the opening to form the flow guiding structure.

8. A method for manufacturing a substrate using the device according to claim 6, wherein the method comprises:
introducing conductive melt into the first overflow tank, and introducing non-conductive melt the second overflow tank;
enabling the conductive melt and the non-conductive melt to overflow from the first overflow tank and the second overflow tank, respectively, and to flow through the flow guiding structure along the first side wall and the second side wall to form a substrate strip; and
after the substrate strip falls down, forming the substrate comprising a conductive portion and a non-conductive portion by drawing.

9. The method according to claim 8, wherein the enabling the conductive melt and the non-conductive melt to overflow from the first overflow tank and the second overflow tank, respectively, and to flow through the flow guiding structure along the first side wall and the second side wall to form the substrate strip, comprises:
according to a thickness of the substrate and a design requirement of a thickness ratio of the conductive portion and the non-conductive portion, controlling overflow speeds of the conductive melt and the non-conductive melt to enable formation of the substrate strip by guiding the conductive melt and the non-conductive melt using the flow guiding structure.

10. The method according to claim 8, wherein the non-conductive melt comprises SiO₂, Al₂O₃, B₂O₃, BaO, CaO, MgO, SnO₂, SrO, and Fe₂O₃; and
the conductive melt comprises SiO₂, Al₂O₃, B₂O₃, BaO, CaO, MgO, SnO₂, SrO, Fe₂O₃, and one or more of zinc oxide, nano silver, indium oxide, and tin oxide.

11. The method according to claim 10, wherein mass percentages of materials in the non-conductive melt are: 60%˜73% for SiO₂, 5%˜22% for Al₂O₃, 1%˜6% for B₂O₃, 5%˜15% for BaO, 0%˜20% for SrO, 0%˜13% for CaO, 0%˜11% for MgO, 0.005%˜2% for SnO₂, and 0.003%˜0.1% for Fe₂O₃; and
mass percentages of materials in the conductive melt are: 50%˜65% for SiO₂, 4%˜18% for Al₂O₃, 1%˜5% for B₂O₃, 4%˜13% for BaO, 0%˜15% for SrO, 0%˜10% for CaO, 0%˜9% for MgO, 0.005%˜1.5% for SnO₂, 0.003%˜0.1% for Fe₂O₃, 0%˜20% for zinc oxide, 0%˜20% for nano silver, 0%˜20% for indium oxide, and 0%˜20% for tin oxide; wherein a total mass percentage of the zinc oxide, the nano silver, the indium oxide, and the tin oxide is 15%˜30%.

12. A display device, comprising a substrate, wherein the substrate has a single layer structure and comprises a conductive portion and a non-conductive portion in a thickness direction.

13. The display device according to claim 12, wherein the display device comprises an array substrate, and the substrate is disposed opposite to the array substrate;
the conductive portion in the substrate is disposed at a side close to the array substrate as a common electrode layer, and the non-conductive portion in the substrate is disposed at a side away from the array substrate; or
the conductive portion in the substrate is disposed at a side away from the array substrate, and the non-conductive portion in the substrate is disposed at a side close to the array substrate.

14. The display device according to claim 12, wherein a ratio of a thickness of the conductive portion to a thickness of the non-conductive portion ranges from 1:1 to 1:4.

15. The display device according to claim 12, wherein the substrate has a thickness ranging from 0.4 mm to 1.0 mm.

16. The display device according to claim 12, wherein the non-conductive portion comprises SiO₂, Al₂O₃, B₂O₃, BaO, CaO, MgO, SnO₂, SrO, and Fe₂O₃; and
the conductive portion comprises SiO₂, Al₂O₃, B₂O₃, BaO, CaO, MgO, SnO₂, SrO, Fe₂O₃, and one or more of zinc oxide, nano silver, indium oxide, and tin oxide.

17. The display device according to claim 16, wherein mass percentages of materials in the non-conductive portion are: 60%˜73% for SiO₂, 5%˜22% for Al₂O₃, 1%˜6% for B₂O₃, 5%˜15% for BaO, 0%˜20% for SrO, 0%˜13% for CaO, 0%˜11% for MgO, 0.005%˜2% for SnO₂, and 0.003%˜0.1% for Fe₂O₃; and
mass percentages of materials in the conductive portion are: 50%˜65% for SiO₂, 4%˜18% for Al₂O₃, 1%˜5% for B₂O₃, 4%˜13% for BaO, 0%˜15% for SrO, 0%˜10% for CaO, 0%˜9% for MgO, 0.005%˜1.5% for SnO₂, 0.003%˜0.1% for Fe₂O₃, 0%˜20% for zinc oxide, 0%˜20% for nano silver, 0%˜20% for indium oxide, and 0%˜20% for tin oxide; wherein a total mass percentage of the zinc oxide, the nano silver, the indium oxide, and the tin oxide is 15%˜30%.
